(19) United States
(12) Patent Application Publication
(10) Pub. No.: US 2013/0306321 A1
(43) Pub. Date: Nov. 21, 2013

(54) LIQUEFIED INDUSTRIAL GAS BASED SOLUTION IN HYDRAULIC FRACTURING

(71) Applicants: Camille LANCTOT-DOWNS, Edmonton (CA); Michel EPINEY, Duvernay (CA); Fabrice LABERGE, Outremont (CA); Vasuhi RASANAYAGAM, Newark, DE (US); Meenakshi SUNDARAM, Newark, DE (US)

(72) Inventors: Camille LANCTOT-DOWNS, Edmonton (CA); Michel EPINEY, Duvernay (CA); Fabrice LABERGE, Outremont (CA); Vasuhi RASANAYAGAM, Newark, DE (US); Meenakshi SUNDARAM, Newark, DE (US)

(21) Appl. No.: 13/473,852

(22) Filed: May 17, 2012

(51) Int. Cl. E21B 43/26; C09K 8/80; C09K 8/62

(52) U.S. Cl. 166/308.1; 507/268; 507/240; 507/237; 507/200; 507/273; 507/271; 507/266; 507/252; 507/267; 507/269; 507/276; 507/211; 507/216; 507/244; 507/225; 507/260; 507/235; 507/258

(57) ABSTRACT

The present invention is a cryogenic subterranean fracturing fluid, comprising a liquefied industrial gas and a first additive. The liquefied industrial gas may be liquefied carbon dioxide, liquefied nitrogen, or a blend of the two. The liquefied industrial gas mixture should be substantially free of water. In this context, substantially free of water means less than 10% water by volume, or preferably less than 5% water by volume. In addition to the first additive, a proppant may be added to the fracturing fluid. In addition to the biocide and/or proppant additional additives may be added to the liquefied industrial gas as required. Non-limiting examples of such additives include ozone, a friction reducer, an acid, a gelling agent, a breaker, a scale inhibitor, a clay stabilizer, a corrosion inhibitor, an iron controller, an oxygen scavenger, a surfactant, a cross-linker, a non-emulsifier, a Ph Adjusting agent, or any combination thereof.

### TECHNICAL FIELD

This invention relates to a method of fracturing subterranean formations penetrated by a well bore utilizing liquid carbon dioxide or liquid as the carrier for chemicals and/or biocides instead of water.

### BACKGROUND

The treatment of subterranean formations penetrated by a well bore to stimulate the production of hydrocarbons therefrom or the ability of the formation to accept injected fluids has long been known in the art. One of the most common methods of increasing productivity of a hydrocarbon-bearing formation is to subject the formation to a fracturing treatment. This treatment is effected by injecting a liquid, gas or two-phase fluid which generally is referred to as a fracturing fluid down the well bore at sufficient pressure and flow rate to fracture the subterranean formation. A proppant material such as sand, fine gravel, sintered bauxite, glass beads or the like can be introduced into the fractures to keep them open. The propped fracture provides larger flow channels through which an increased quantity of a hydrocarbon can flow, thereby increasing the productive capability of a well.

A traditional hydraulic fracturing technique utilizes a water or oil-based fluid to fracture a hydrocarbon-bearing formation.

### SUMMARY

The present invention is a cryogenic subterranean fracturing fluid, comprising a liquefied industrial gas and a first additive. The liquefied industrial gas may be liquefied carbon dioxide, liquefied nitrogen, or a blend of the two. The liquefied industrial gas mixture should be substantially free of water. In this context, substantially free of water means less than 10% water by volume, or preferably less than 5% water by volume. In addition to the first additive, a proppant may be added to the fracturing fluid. In addition to the biocide and/or proppant additional additives may be added to the liquefied industrial gas as required. Non-limiting examples of such additives include ozone, a friction reducer, an acid, a gelling agent, a breaker, a scale inhibitor, a clay stabilizer, a corrosion inhibitor, an iron controller, an oxygen scavenger, a surfactant, a cross-linker, a non-emulsifier, a Ph Adjusting agent, or any combination thereof.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

A hydraulic fracture is formed by pumping the fracturing fluid into the wellbore at a rate sufficient to increase pressure downhole to exceed that of the fracture gradient of the rock. The rock cracks and the fracture fluid continues farther into the rock, extending the crack still farther, and so on. Operators typically try to maintain “fracture width”, or slow its decline, following treatment by introducing a proppant into the injected fluid, a material, such as grains of sand, ceramic, or other particulates, that prevent the fractures from closing when the injection is stopped. Consideration of proppant strengths and prevention of proppant failure becomes more important at deeper depths where pressure and stresses on fractures are higher. The propped fracture is permeable enough to allow the flow of formation fluids to the well. Formation fluids include gas, oil, salt water, fresh water and fluids introduced to the formation during completion of the well during fracturing.

The location of one or more fractures along the length of the borehole is strictly controlled by various different methods which create or seal-off holes in the side of the wellbore. Typically, hydraulic fracturing is performed in cased wellbores and the zones to be fractured are accessed by perforating the casing at those locations.

The fluid injected into the rock is typically a slurry of water, proppants, and chemical additives. Additionally, gels, foams, and compressed gases, including nitrogen, carbon dioxide and air can be injected.

Various types of proppant include silica sand, resin-coated sand, and man-made ceramics. These vary depending on the type of permeability or grain strength needed. The most commonly utilized proppant is silica sand. However, proppants of uniform size and shape, such as a ceramin proppant, is believed to be more effective. Due to a higher porosity within the fracture, a greater amount of oil and natural gas is liberated. Sand containing naturally radioactive minerals is sometimes used so that the fracture trace along the wellbore can be measured.

Chemical additives are applied to tailor the injected material to the specific geological situation, protect the well, and improve its operation, though the injected fluid is approximately 98-99.5% water, varying slightly based on the type of well. The composition of injected fluid is sometimes changed as the fracturing job proceeds. Often, acid is initially used to scour the perforations and clean up the near-wellbore area. Afterward, high pressure fracture fluid is injected into the wellbore, with the pressure above the fracture gradient of the rock. This fracture fluid contains water-soluble gelling agents (such as guar gum) which increase viscosity and efficiently deliver the proppant into the formation. As the fracturing process proceeds, viscosity reducing agents such as oxidizers and enzyme breakers are sometimes then added to the fracturing fluid to deactivate the gelling agents and encourage flowback. The proppant's purpose is primarily to provide a permeable and permanent filler to fill the void created during the fracturing process.

At the end of the job the well is commonly flushed with water (sometimes blended with a friction reducing chemical) under pressure. Injected fluid is to some degree recovered and is managed by several methods, such as underground injection control, treatment and discharge, recycling, or temporary storage in pits or containers while new technology is being developed to better handle wastewater and improve reusability. Although the concentrations of the chemical additives are very low, the recovered fluid may be harmful due in part to hydrocarbons picked up from the formation.

Hydraulic fracturing equipment used in oil and natural gas fields usually consists of a slurry blender, one or more high pressure, high volume fracturing pumps (typically powerful triplex, or quintiplex pumps) and a monitoring unit. Associated equipment includes fracturing tanks, one or more units for storage and handling of proppant, high pressure treating iron, a chemical additive unit (used to accurately monitor chemical addition), low pressure flexible hoses, and many gauges and meters for flow rate, fluid density, and treating pressure. Fracturing equipment operates over a range of pressures and injection rates, and can reach up to 100 megapascals (15,000 psi) and 265 litres per second (9.4 cu ft/s) (100 barrels per minute).^{[} The present invention is a cryogenic subterranean fracturing fluid, that includes at least a liquefied industrial gas and a first additive. The liquefied industrial gas may be liquefied carbon dioxide, liquefied nitrogen, or a blend of the two. Other liquefied industrial gases may be included in a mixture, but the primary components will be liquefied carbon dioxide or liquefied nitrogen. The liquefied industrial gas mixture should be substantially free of water. In this context, substantially free of water means less than 10% water by volume, or preferably less than 5% water by volume. In addition to the first additive, a proppant may be added to the fracturing fluid. Any proppant known in the art

As discussed above, in hydraulic or gas fracturing, a number of additives are routinely added as the particular site requires. In the present invention, the first additive may be a biocide. The biocide may be any chemical known to one of ordinary skill in the art. Non-limiting examples of such biocides include glutaraldehyde, quaternary ammonium chloride, tetrakis hydroxymethyl-phosphonium sulfate, or a combination thereof.

In addition to the first additive, a proppant may be added to the fracturing fluid. Any proppant known in the art may be used. Non-limiting examples of such proppants include quartz sand, aluminum balls, walnut shells, glass beads, plastic balls, ceramic, and resin-clad sand.

In addition to the biocide and/or proppant, a second additive, or additional additives, may be added to the liquefied industrial gas as required. Any additional additives known in the art may be added. Non-limiting examples of such additives include ozone, a friction reducer, an acid, a gelling agent, a breaker, a scale inhibitor, a clay stabilizer, a corrosion inhibitor, an iron controller, an oxygen scavenger, a surfactant, a cross-linker, a non-emulsifier, a Ph Adjusting agent, or any combination thereof

The combination of liquefied industrial gas, proppant, biocide and any additional additives should be substantially free of water.

The additives may be introduced into the liquefied industrial gas prior to the introduction into said formation, and stored in admixed liquid form. The additives may introduced into the liquid nitrogen in such a way as to form discrete, frozen masses, thereby producing a slurry with the liquid nitrogen. The additives may be introduced into the liquid carbon dioxide in such a way as to form miscible liquid with the liquid carbon dioxide.

Any cross-linker known to one skilled in the art may added, as needed, to the liquefied industrial gas. Non-limiting examples of such cross-linkers include petroleum distillate, hydrotreated light petroleum distillate, potassium metaborate, triethanolamine zirconate, sodium tetraborate, boric acid, zirconium complex, borate salts, ethylene glycol, methanol, or a combination thereof.

Any non-emulsifier known to one skilled in the art may added, as needed, to the liquefied industrial gas. Non-limiting examples of such non-emulsifiers include non-emulsifiers lauryl sulfate, isopronanol, ethylene glycol, or a combination thereof.

Any Ph adjusting agent known to one skilled in the art may added, as needed, to the liquefied industrial gas. Non-limiting examples of such pH adjusting agents include is sodium hydroxide, potassium hydroxide, acetic acid, sodium carbonate, potassium carbonate, or a combination thereof.

Any acid known to one skilled in the art may added, as needed, to the liquefied industrial gas. Non-limiting examples of such acids hydrochloric acid, muriatic acid or a combination thereof.

Any gelling agent known to one skilled in the art may added, as needed, to the liquefied industrial gas. Non-limiting examples of such gelling agents include guar gum, petroleum distillate, hydrotreated light petroleum distillate, methanol, polysaccharide blend, ethylene glycol, hydroxyethyl cellulose, or a combination thereof.

Any breaker known to one skilled in the art may added, as needed, to the liquefied industrial gas. Non-limiting examples of such breakers include ammonium persulfate, magnesium peroxide, magnesium oxide, calcium chloride, sodium chloride, or a combination thereof.

Any corrosion inhibiter known to one skilled in the art may added, as needed, to the liquefied industrial gas. Non-limiting examples of such corrosion inhibitor include isopropanol, methanol, formic Acid, acetaldehyde, N, n-dimethyl formamide, or a combination thereof.

Any oxygen scavenger known to one skilled in the art may added, as needed, to the liquefied industrial gas. A non-limiting example of such a corrosion inhibitor is ammonium bisulfate.

Any surfactant known to one skilled in the art may added, as needed, to the liquefied industrial gas. A non-limiting example of such a surfactant is isopropanol.

Any clay stabilizer known to one skilled in the art may added, as needed, to the liquefied industrial gas. Non-limiting examples of such clay stabilizer include choline chloride, tetramethyl ammonium chloride, sodium chloride, or a combination thereof.

Any friction reducer known to one skilled in the art may added, as needed, to the liquefied industrial gas. Non-limiting examples of such friction reducer include polyacrylamide, petroleum distillate, hydrotreated light petroleum distillate, methanol, ethylene glycol, or a combination thereof.

Any scale inhibiter known to one skilled in the art may added, as needed, to the liquefied industrial gas. Non-limiting examples of such scale inhibitor include ethylene glycol, copolymer of acrylamide and sodium acrylate, sodium polycarboxylate, phosphonic acid salt, or a combination thereof.

Any iron controller known to one skilled in the art may added, as needed, to the liquefied industrial gas. Non-limiting examples of such iron controller include citric acid, acetic acid, thioglycolic acid, 2-hydroxy 1,2,3-propaneticoboxylic acid, sodium erythorbate, or a combination thereof.

This invention also includes a method of fracturing a subterranean formation penetrated by a well bore comprising: introducing cryogenic subterranean fracturing fluid, comprising a liquefied industrial gas, a biocide, a proppant, and at least a first additive into said formation.

What is claimed is:

1: A cryogenic subterranean fracturing fluid, comprising a liquefied industrial gas and a first additive.

2: The cryogenic subterranean fracturing fluid of claim 1, wherein said liquefied industrial gas, and said first additive are substantially free of water.

3: The cryogenic subterranean fracturing fluid of claim 2, wherein there is less than 10% water by volume.

4: The cryogenic subterranean fracturing fluid of claim 3, wherein there is less than 5% water by volume.

5: The cryogenic subterranean fracturing fluid of claim 1, wherein said first additive is a biocide.

6: The cryogenic subterranean fracturing fluid of claim 5, further comprising a proppant.

7: The cryogenic subterranean fracturing fluid of claim 6, further comprising at least a second additive.

8: The cryogenic subterranean fracturing fluid of claim 7, wherein said liquefied industrial gas, said biocide, and/or said second additive are substantially free of water.

9: The cryogenic subterranean fracturing fluid of claim 8, wherein there is less than 10% water by volume.

10: The cryogenic subterranean fracturing fluid of claim 9, wherein there is less than 5% water by volume.

11: The cryogenic subterranean fracturing fluid of claim 7, wherein said first additive is introduced into said liquefied industrial gas prior to said introduction into said formation, and stored in admixed liquid form.

12: The cryogenic subterranean fracturing fluid of claim 1, wherein said liquefied industrial gas is liquid carbon dioxide.

13: The cryogenic subterranean fracturing fluid of claim 1, wherein said liquefied industrial gas is liquid nitrogen.

14: The cryogenic subterranean fracturing fluid of claim 1, wherein said liquefied industrial gas is a combination of liquid carbon dioxide and liquid nitrogen.

15: The cryogenic subterranean fracturing fluid of claim 12, wherein said first additive is introduced into said liquid carbon dioxide In such a way as to form miscible liquid with liquid carbon dioxide.

16: The cryogenic subterranean fracturing fluid of claim 13, wherein said first additive is introduced into said liquid nitrogen in such a way as to form discrete, frozen masses, thereby producing a slurry with the liquid nitrogen.

17: The cryogenic subterranean fracturing fluid of claim 1, wherein said biocide is glutaraldehyde, quaternary ammonium chloride, tetrakis hydroxymethyl-phosphonium sulfate, or a combination thereof.

18: The cryogenic subterranean fracturing fluid of claim 1, wherein said first additive comprises one or more of the following: ozone, a friction reducer, an acid, a gelling agent, a breaker, a scale inhibitor, a clay stabilizer, a corrosion inhibitor, an iron controller, an oxygen scavenger, a surfactant, a cross-linker, a non-emulsifier, a Ph Adjusting agent, or any combination thereof.

19: The cryogenic subterranean fracturing fluid of claim 18, where said cross-linker is petroleum distillate, hydrotreated light petroleum distillate, potassium metaborate, triethanolamine zirconate, sodium tetraborate, boric acid, zirconium complex, borate salts, ethyleneglycol, methanol, or a combination thereof.

20: The cryogenic subterranean fracturing fluid of claim 18, where said non-emulsifiers lauryl sulfate, isopronanol, ethylene glycol, or a combination thereof.

21: The cryogenic subterranean fracturing fluid of claim 18, where said Ph adjusting agent is sodium hydroxide, potassium hydroxide, acetic acid, sodium carbonate, potassium carbonate, or a combination thereof.

22: The cryogenic subterranean fracturing fluid of claim 18, wherein said acid is hydrochloric acid, muriatic acid or a combination thereof.

23: The cryogenic subterranean fracturing fluid of claim 18, wherein said gelling agent comprises one or more of the following: guar gum, petroleum distillate, hydrotreated light petroleum distillate, methanol, polysaccharide blend, ethylene glycol, hydroxyethyl cellulose, or a combination thereof.

24: The cryogenic subterranean fracturing fluid of claim 18, wherein said breaker comprises one or more of the following: ammonium persulfate, magnesium peroxide, magnesium oxide, calcium chloride, sodium chloride, or a combination thereof.

25: The cryogenic subterranean fracturing fluid of claim 18, wherein said corrosion inhibitor comprises one or more of the following: isopropanol, methanol, formic Acid, acetaldehyde, N, n-dimethyl formamide, or a combination thereof.

26: The cryogenic subterranean fracturing fluid of claim 18, wherein said oxygen scavenger is ammonium bisulfate.

27: The cryogenic subterranean fracturing fluid of claim 18, wherein said surfactant is isopropanol.

28: The cryogenic subterranean fracturing fluid of claim 18, wherein said clay stabilizer comprises one or more of the following: choline chloride, tetramethyl ammonium chloride, sodium chloride, or a combination thereof.

29: The cryogenic subterranean fracturing fluid of claim 18, wherein said friction reducer comprises one or more of the following: polyacrylamide, petroleum distillate, hydrotreated light petroleum distillate, methanol, ethylene glycol, or a combination thereof.

30: The cryogenic subterranean fracturing fluid of claim 18, wherein aid scale inhibitor comprises one or more of the following: ethylene glycol, copolymer of acrylamide and sodium acrylate, sodium polycarboxylate, phosphonic acid salt, or a combination thereof.

31: The cryogenic subterranean fracturing fluid of claim 18, wherein said iron controller comprises one or more of the following: citric acid, acetic acid, thioglycolic acid, 2-hydroxy 1,2,3-propaneticoboxylic acid, sodium erythorbate, or a combination thereof.

32: A method of fracturing a subterranean formation penetrated by a well bore comprising: introducing cryogenic subterranean fracturing fluid, comprising a liquefied industrial gas, a biocide, a proppant, and at least a first additive into said formation.

33: A method of fracturing a subterranean formation penetrated by a well bore comprising: introducing cryogenic subterranean fracturing fluid, comprising a liquefied industrial gas, a biocide, a proppant, and at least a first additive into said formation, wherein said cryogenic subterranean fracturing fluid is substantially free of water.
